(19) United States
(12) Patent Application Publication
(10) Pub. No.: US 2005/0197866 A1
(43) Pub. Date: Sep. 8, 2005

(54) Preneed insurance services system

(76) Inventors: Joe Salcedo, Blairsville, GA (US); Marion Anandappa, Tucker, GA (US); J. Craig Hill, Duluth, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 11/072,664

(22) Filed: Mar. 4, 2005

Related U.S. Application Data
(60) Provisional application No. 60/550,038, filed on Mar. 4, 2004.

(51) Int. Cl. G06F 17/60

(52) U.S. Cl. 705/4

(57) ABSTRACT

The present invention provides a system, method, and computer-readable medium for providing preneed services. The preneed insurance services system includes a data processing unit, a customer data storage unit, a quote data storage unit, and an insurance data storage unit. The data processing unit receives customer information from a user interface. The customer information is stored and preneed insurance quotes are received, prepared, and stored. Insurance applications can be prepared from the insurance quotes. Additionally, insurance assignment forms and insurance claims can be prepared. The preneed insurance services system also provides a business data storage unit for customization and creation of various business forms.

### CROSS REFERENCE TO RELATED APPLICATION AND CLAIM OF BENEFIT

This application claims the benefit of U.S. Provisional Application 60/550,038, filed on Mar. 4, 2004.

### FIELD OF THE INVENTION

The present invention relates generally to computer software application programs for providing insurance quotes, insurance forms, and business forms, and more particularly to an application program or software module for providing the preneed services industry with insurance quotes, insurance forms, and business forms.

### BACKGROUND OF THE INVENTION

Dealing with funeral arrangements during a time of misfortune can be overwhelming. There exists not only an emotional burden, but a financial burden involved in preparing for a funeral. Today, a typical funeral with burial often exceeds several thousand dollars. To prevent burdening loved ones with the emotional trauma and the financial hardship involved with arranging funeral services, many individuals have turned to preneed insurance.

The term “preneed” refers to any aspect related to the funding, arranging, or planning of a funeral before the need arises. Preneed insurance provides a cost-effective means for paying for funeral services. Such services can include the burial, the embalming, the casket, the visitation, the transportation, the floral arrangements, and the tombstone. The benefits of prearranging a funeral and acquiring preneed insurance include: providing family members with the insured's desired type of funeral arrangements; reducing stress among family members by eliminating the need to make and pay for funeral plans after the insured's death; taking care of paper work prior to the funeral; and providing the insured with control over his or her funeral arrangements.

Typically, preneed insurance is offered by insurance companies through a local, funeral service caregiver. In both urban and rural communities, funeral home management strongly supports preneed funeral arrangements. Preneed services are considered an “essential” service in the competitive funeral home environment.

Currently, funeral homes primarily use preneed insurance materials that have been provided by insurance companies to promote, sell, complete, and submit preneed insurance applications, assignment forms, and claim forms. These materials are usually supplied in a physical medium and are not available through a comprehensive computer software program. Indeed, the only extensive computer software programs used in funeral homes today provide assistance with “at-need” services. At-need services include funeral services that are arranged at the time they are needed—specifically, after death.

While fulfilling their respective purposes, current preneed insurance support does not meet the needs or desires of consumers and preneed service providers. Funeral directors have expressed dissatisfaction with current preneed insurance support materials received from insurance companies.

Funeral homes desire preneed insurance support that provides the ability to compare competing insurance companies' policy prices, and that provides the ability to easily view competing insurance companies' payment plan choices. Funeral homes desire preneed insurance support that offers the ability to produce insurance quotes quickly and accurately, and that provides the ability to customize the preneed quotes. Additionally, funeral service caregivers desire preneed insurance support that offers choices to their consumers, while providing an easy-to-access database file containing customer information and insurance information.

Even further, funeral service caregivers desire preneed insurance support that provides appropriate insurance applications, assignment forms, claim forms, and other business forms pertaining to the insurance provider, funeral home, customer information, and state regulations or requirements. Consumers and funeral homes desire all of the features described above in an easy-to-use computer software program.

Therefore, there exists in the preneed services industry a need for a system, method, and computer-readable medium for providing insurance quotes, insurance forms, and business forms.

### BRIEF SUMMARY OF THE INVENTION

The present invention overcomes several of the disadvantages of the existing materials and technology by providing a system, method, and computer-readable medium for providing insurance quotes, insurance forms, and business forms. Generally, the system is designed to: receive information about the customer inquiring about preneed insurance services; provide preneed insurance quotes from one or more insurance providers; provide preneed insurance applications and assignment forms from the competing insurance providers; and provide insurance claims forms from the respective insurance providers.

The system may include a data processing unit, a customer data storage unit, a quote data storage unit, and an insurance data storage unit. The data processing unit receives customer data, quote data, and insurance data. The customer data storage unit receives and stores customer data and provides stored customer data to the data processing unit. The quote data storage unit provides stored quote data to the data processing unit. The insurance data storage unit provides stored insurance data to the data processing unit. Through a user interface, the data processing unit may receive customer's data, display preneed insurance quotes for the customer, and process an application for preneed services or insurance based on the received customer's data.

Other objects, features, and advantages of the present invention will become apparent to those skilled in the art upon reading the following specification in conjunction with the accompanying drawings.

### BRIEF DESCRIPTION OF DRAWINGS

FIG. 1 is a block diagram illustrating a preneed insurance services system in accordance with an embodiment of the present invention.

FIG. 2 displays a block diagram representation of a computing environment which may be utilized in accordance with some embodiments of the present invention.

FIG. 3 is a block diagram illustrating a system for providing preneed insurance quotes in accordance with an embodiment of the present invention.

FIG. 4 is a block diagram illustrating a system for receiving quote data and insurance data through a computer network in accordance with an embodiment of the present invention.

FIG. 5 is a block diagram illustrating a system for receiving business information for preneed services in accordance with an embodiment of the present invention.

FIG. 6 is a block diagram illustrating a system with a user interface for providing preneed insurance quotes in accordance with an embodiment of the present invention.

FIG. 7 is a block diagram illustrating a data backup system for preneed services in accordance with an embodiment of the present invention.

FIG. 8 is a block diagram illustrating a data backup system for preneed services through a computer network in accordance with an embodiment of the present invention.

FIG. 9 is a block diagram illustrating a data synchronization system for preneed services in accordance with an embodiment of the present invention.

FIG. 10 is a block diagram illustrating a data synchronization system for preneed services through a computer network in accordance with an embodiment of the present invention.

FIG. 11 is a block diagram illustrating a registration system for preneed services through a computer network in accordance with an embodiment of the present invention.

FIG. 12 is a block diagram illustrating an error checking system for preneed services in accordance with an embodiment of the present invention.

FIG. 13 is a flow chart illustrating a method of providing preneed insurance quotes in accordance with an embodiment of the present invention.

FIG. 14 is a flow chart illustrating a method of preparing preneed insurance applications in accordance with an embodiment of the present invention.

FIG. 15A is a flow chart illustrating a method of preparing preneed insurance claim forms in accordance with an embodiment of the present invention.

FIG. 15B is a flow chart illustrating a method of preparing preneed insurance assignment forms in accordance with an embodiment of the present invention.

FIG. 16 is a flow chart illustrating a method of creating preneed business forms in accordance with an embodiment of the present invention.

FIG. 17 is a flow chart illustrating a method of backing up preneed services data in accordance with an embodiment of the present invention.

FIG. 18 is a flow chart illustrating a method of synchronizing preneed services data in accordance with an embodiment of the present invention.

### DETAILED DESCRIPTION OF INVENTION

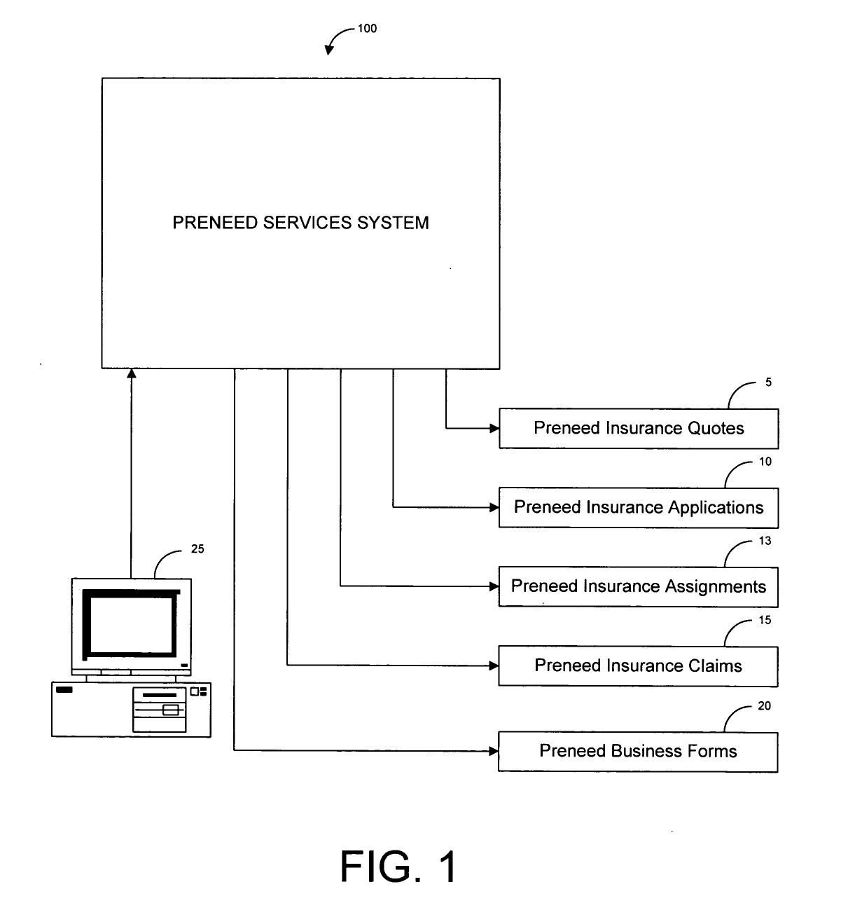

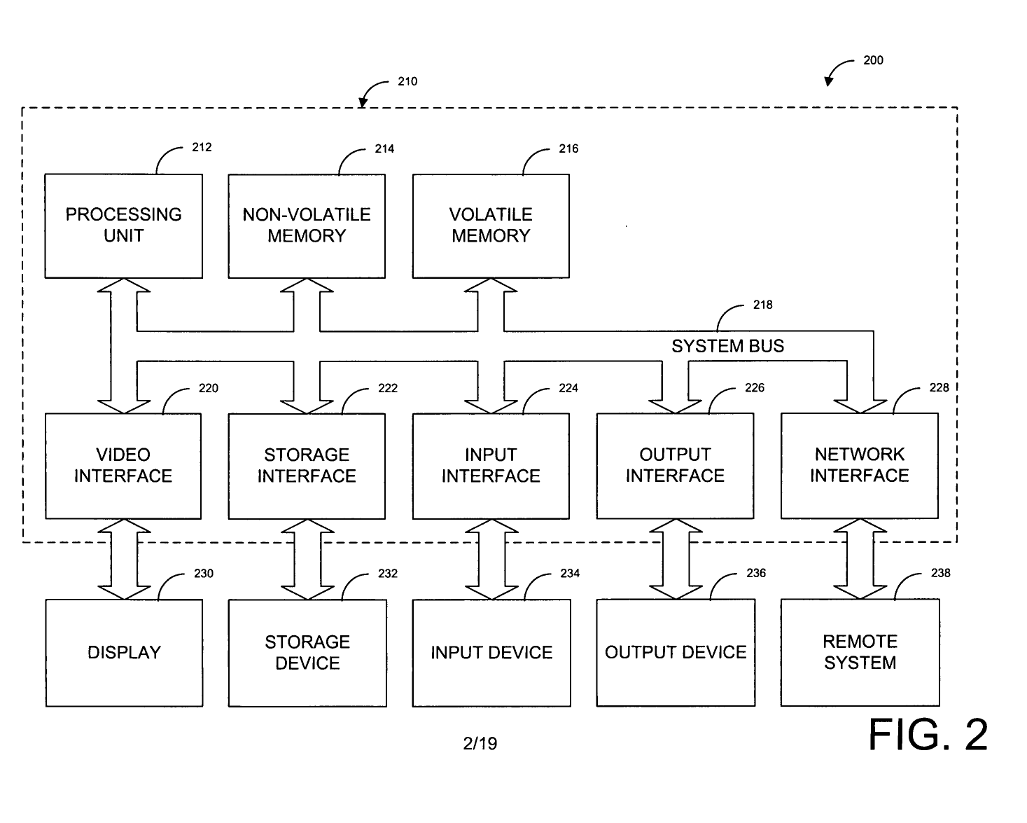

Referring now to the drawings, in which like numerals refer to like components or steps throughout the several views of the embodiments of the present invention, FIG. 1 is a block diagram illustrating a preneed insurance services system 100 in accordance with an embodiment of the present invention. The preneed insurance services system 100 is configured with hardware and software appropriate to perform tasks and provide capabilities and functionality as described herein. Generally, the preneed insurance services system 100 comprises software modules executed on a computer 25, as described more fully below with reference to FIG. 2. The preneed insurance services system 100 receives data from a user through an input interface of a computer 25 and manipulates the data to create preneed insurance quotes 5, preneed insurance applications 10, preneed assignment forms 13, preneed insurance claims 15, and preneed business forms 20.

The preneed insurance services system 100 is provided as a computer software application. The invention can be stored on a CD-ROM that can be sent to funeral home businesses. Upon receipt of the preneed services CD-ROM, a funeral home agent installs the computer software application onto a personal computer. The agent has the option of installing a trial version of the software or the complete version.

The funeral home agent can begin by customizing the software. The agent provides information regarding the funeral home, such as the name, address, and phone number. The agent can also provide the funeral home's logo, slogan, or servicemark. The supervising agent of the funeral home can create accounts for other agents of the funeral home, while restricting access to certain software functionality. For example, the supervising agent can create a username and password for each of the agents. Then, the supervising agent can limit the functionality of the particular username. One such limitation can be the ability to view, modify, or remove the profiles of other funeral home agents. The preneed insurance services system 100 may also be utilized by insurance agencies for promoting their products, or for monitoring the productivity of a particular funeral home.

Each agent can log into the software program and use insurance forms and customized business forms for the funeral home. When a customer arrives to discuss preneed insurance services, the agent can enter in customer information, such as the customer's name, sex, phone number, date of birth, and age. Based on this information, the preneed insurance services system 100 provides the agent with an insurance quote. The insurance quote lists the rates of one or more insurance providers' plans. The list can be displayed based on user preference, such as lowest premium, highest commission amount, highest face amount, or all plans. Additionally, the preneed insurance services system 100 may generate a future cost amount for funeral arrangements to entice customers to purchase preneed insurance services.

If the customer decides not to purchase preneed insurance, the insurance quote can be saved for future use. When the customer is ready to purchase preneed insurance, the funeral home agent can select the preferred insurance provider(s) plan(s). The preneed insurance services system 100 requests any additional customer information that is necessary to complete the proper paperwork. The agent supplies the information, and the preneed insurance services system 100 provides the agent with the proper insurance application(s) and any additional forms required by the funeral home, the insurance company, or state law. The application and additional forms can be sent to the insurance provider(s) to purchase the policy or policies for the customer. The preneed insurance policy can be assigned to a funeral home at the time the application is completed or at a later time.

When the customer dies, a claim can be made on the insurance policy or policies. The agent can supply the claim information to the preneed insurance services system 100. The preneed insurance services system 100 creates the necessary claim forms and any additional forms required by the insurance company or state law. Then, the claim and additional forms can be sent to the appropriate insurance provider(s). The preneed insurance services system 100 saves the claim information for future use.

The preneed insurance services system 100 provides the funeral home with an easy tool to provide the best services to the customer, while reducing the amount of time a funeral home agent needs to spend doing paperwork. The agent gains more time to focus on the customer, thus enhancing the relationship between the funeral home and the customer. Additionally, the preneed insurance services system 100 assists the user and customer with making informed decisions about preneed insurance services, while providing competitive rates from leading insurance companies.

Focusing more specifically on the functionality described above, in a preferred embodiment of the present invention, an agent of the funeral home provides customer data to the preneed insurance services system 100, through a user interface displayed by the computer 25, to create preneed insurance quotes 5. The customer data includes, but is not limited to, the customer's name, sex, phone number, date of birth, age, and state of residence. The preneed insurance services system 100 receives the customer data and uses it to determine the insurance rates from one or more insurance providers' plans. The preneed insurance quote 5 provides, to the user and customer, an estimate on the cost of purchasing preneed insurance from each insurance provider.

In an alternative embodiment of the present invention, the preneed insurance services system 100 further creates a preneed insurance application 10. The agent at the funeral home can use the preneed insurance quote 5 to prepare a preneed insurance application 10 for the customer applying for preneed insurance. The user or customer selects an insurance provider's plan(s) from the list of rates provided by the preneed insurance quote 5. Next, the agent provides additional customer data, such as the name of beneficiary and the customer's social security number, to the preneed insurance services system 100 via the input device of the computer 25. The preneed insurance services system 100 uses the customer data to create a preneed insurance application 10 for the selected insurance provider(s). The preneed insurance application 10 can then be sent to the appropriate insurance provider(s) for approval. It will be understood that the preneed insurance application(s) can be sent electronically or through traditional mail carriers.

The preneed insurance services system 100 can create assignment forms 13. The assignment form 13 is generally used to name the funeral home as the irrevocable beneficiary of the insurance policy death benefits. At the time of death, the funeral home will then submit the claim to the insurance company and the death benefit check will be sent to the funeral home. The deceased's (i.e., insured's) survivors will not be encumbered with having to file the claim with the insurance provider.

In yet another embodiment, the preneed insurance services system 100 can create preneed insurance claims 15. Preneed insurance claims 15 are used when a customer or funeral home requests benefits from the preneed insurance policy. For example, the funeral home or family of the insured will make a claim on the preneed insurance policy or policies for payment of funeral arrangements upon the insured's death. The funeral home agent or beneficiary provides the customer information regarding the claim to the preneed insurance services system 100 via the input interface of the computer 25 (e.g., using a user interface displayed by the computer 25). The preneed insurance services system 100 receives the information and provides a preneed insurance claim 15 with regard to the insurance provider(s). The preneed insurance claim 15 can be sent to the appropriate insurance provider(s) requesting payment under the insurance policy or policies.

In still another embodiment, the preneed insurance services system 100 can create preneed business forms 20. The funeral home can create custom forms for its business by providing business data to the preneed insurance services system 100. The funeral home agent provides business data, such as the business name, address, phone number, email address, and logo, through the computer 25. The preneed insurance services system 100 uses the business data received to create preneed business forms 20 customized for the funeral home business. For example, preneed insurance quotes 5 and reports can be customized to include the business logo of the funeral home.

The present invention can entail all of the embodiments described above or any combination thereof. It will be clear, however, to one skilled in the art that the invention is not restricted to the embodiments described, and that many modifications and additions are possible without departing from the essence of the present invention.

One skilled in the art will recognize that all of the components of the preneed insurance services system 100 may be connected using any appropriate type of connection for bi-directional communication of signals and/or media including, but not limited to, analog, digital, wired and wireless communication channels. Such communication channels may utilize, but not be limited to, copper wire, optical fiber, radio frequency, infrared, satellite, or other facilities and media.

FIG. 2 displays a block diagram representation of a computing environment 200 which may be utilized in accordance with some embodiments of the present invention. The preneed insurance services system 100 is operational with numerous general purpose or special purpose computing system environments or configurations that include, for example and not limitation, a processor and memory. Such computer system environments (e.g., computer 25) of the preneed insurance services system 100 may include, but is not limited to, personal computers, mainframe computers, servers, hand-held or laptop devices, multiprocessor systems, microprocessor-based systems, set top boxes, programmable consumer electronics, network PCs, minicomputers, mainframe computers, distributed computing environments that include any of the above systems or devices, and the like. It should be understood, however, that the features and aspects of the exemplary embodiment of the present invention may be implemented by or into a variety of systems and system configurations and any examples provided within this description are for illustrative purposes only.

FIG. 2 and the following discussion provide a general overview of a platform onto which an embodiment of the present invention, or portions thereof, may be integrated, implemented and/or executed. Although reference has been made to instructions within a software program being executed by a processing unit, those skilled in the art will understand that at least some of the functions performed by the software may also be implemented by using hardware components, state machines, or a combination of any of these techniques. In addition, a software program which may implement an embodiment of the present invention may also run as a stand-alone program or as a software module, routine, or function call, operating in conjunction with an operating system, another program, system call, interrupt routine, library routine, or the like. The term program module is used herein to refer to software programs, routines, functions, macros, data, data structures, or any set of machine readable instructions or object code, or software instructions that may be compiled into such, and executed by a processing unit 212. Those skilled in the art will appreciate that the computing environment 200 illustrated in FIG. 2 may take on many forms and may be directed towards performing a variety of functions. Generally, the computing environment 200 may be any system that includes a computer processor. Examples of such forms and functions may include, but are not limited to, personal computers, hand-held devices such as personal data assistants, note-book computers, lap-top computers, mainframe computers, servers and a variety of other applications, each of which may serve as an exemplary environment for embodiments of the present invention.

The exemplary computing device 210 (e.g., communication device 106) may comprise various components including, but not limited to, a processing unit 212, non-volatile memory 214, volatile memory 216, and a system bus 218 that couples the non-volatile memory 214 and volatile memory 216 to the processing unit 212. The non-volatile memory 214 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, battery backed random access memory (RAM), CDROM, digital versatile disks (DVD) or other optical disk storage, magnetic cassettes, magnetic tape, magneto-optical storage devices, magnetic disk storage or other magnetic storage devices, or any other medium which may be used to store the desired information. The non-volatile memory 214 may provide storage for power-on and reset routines (bootstrap routines) that are invoked upon applying power or resetting the computing device 210. In some configurations the non-volatile memory 214 may provide the basic input/output system (BIOS) routines that are utilized to perform the transfer of information between elements within the various components of the computing device 210.

The volatile memory 216 may include, but is not limited to, a variety of memory types and devices including, but not limited to, random access memory (RAM), dynamic random access memory (DRAM), synchronous dynamic random access memory (SDRAM), double data rate synchronous dynamic random access memory (DDR-SDRAM), bubble memory, registers, or the like. The volatile memory 216 may provide temporary storage for routines, modules, functions, macros, data, etc. that are being or may be executed by, or are being accessed or modified by, the processing unit 212.

In another embodiment, the non-volatile memory 214 and/or the volatile memory 216 may comprise a remote storage facility accessible through a wired and/or wireless network system. Additionally, the non-volatile memory 214 and/or the volatile memory 216 may comprise a memory system comprising a multi-stage system of primary and secondary memory devices, as described above. The primary memory device and secondary memory device may operate as a cache for the other or the second memory device may serve as a backup to the primary memory device. In yet another embodiment, the non-volatile memory 214 and/or the volatile memory 216 may comprise a memory device configured as a simple database file or as a searchable, relational database using a query language, such as SQL.

The computing device 210 may access one or more external display devices 230 such as a CRT monitor, LCD panel, LED panel, electro-luminescent panel, or other display device, for the purpose of providing information or computing results to a user. In some embodiments, the external display device 230 may actually be incorporated into the product itself. The processing unit 212 may interface to each display device 230 through a video interface 220 coupled to the processing unit 210 over the system bus 218.

The computing device 210 may send output information to the display 230 and to one or more output devices 236 such as a speaker, modem, printer, plotter, facsimile machine, RF or infrared transmitter, computer or any other of a variety of devices that may be controlled by the computing device 210. The processing unit 212 may interface to each output device 236 through an output interface 226 coupled to the processing unit 212 over the system bus 218.

The computing device 210 may receive input or commands from one or more input devices 234 such as, but not limited to, a keyboard, pointing device, mouse, modem, RF or infrared receiver, microphone, joystick, track ball, light pen, game pad, scanner, camera, computer or the like. The processing unit 212 may interface to each input device 234 through an input interface 224 coupled to the processing unit 212 over the system bus 218.

It will be appreciated that program modules implementing various embodiments of the present invention may be stored in the non-volatile memory 214, the volatile memory 216, or in a remote memory storage device accessible through the output interface 226 and the input interface 224. The program modules may include an operating system, application programs, other program modules, and program data. The processing unit 212 may access various portions of the program modules in response to the various instructions contained therein, as well as under the direction of events occurring or being received over the input interface 224.

The computing device 210 may provide data to and receive data from one or more other storage devices 232, which may provide volatile or non-volatile memory for storage and which may be accessed by computing device 210. The processing unit 212 may interface to each storage device 232 through a storage interface 222 over the system bus 218.

The interfaces 220, 222, 224, 226, and 228 may include one or more of a variety of interfaces, including but not limited to, cable modems, DSL, T1, T3, optical carrier (e.g., OC-3), V series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

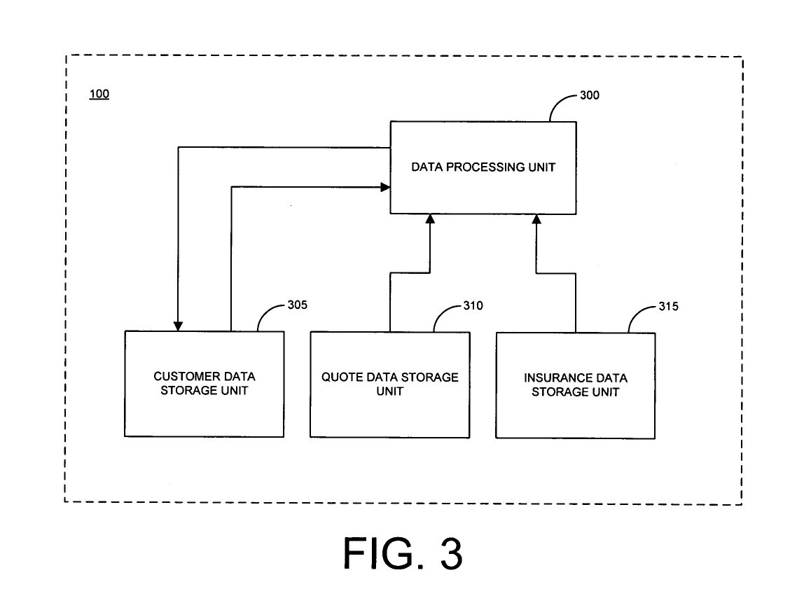

FIG. 3 is a block diagram illustrating a system for providing preneed insurance quotes. Preferably, the preneed insurance services system 100 includes a data processing unit 300, a customer data storage unit 305, a quote data storage unit 310, and an insurance data storage unit 315. The customer data storage unit 305, the quote data storage unit 310, and the insurance data storage unit 315 are in communication with the data processing unit 300. The data processing unit 300 provides customer data to the customer data storage unit 305 for storing purposes. The customer information is used to provide a custom quote for preneed insurance from one or more insurance providers' plans. The data processing unit 300 receives the applicable quote data from the quote data storage unit 310. The applicable quote data corresponds to the customer data. For example, the quote data need only be the data relevant to the customer's state of residence. The data processing unit 300 prepares the insurance quote by manipulating the customer data and insurance quote data. The result is a list of insurance rates available to the customer. The insurance rates can be provided in the order specified by the user—for example, ordered by lowest premium, ordered by highest face amount, or ordered by highest commission amount, or ordered by all plans. The insurance quote is sent by the data processing unit 300 to the customer data storage unit 305 for storage. Additionally, the data processing unit 300 generates a future cost amount of funeral arrangements to entice the customer to purchase preneed insurance. The calculated future cost is calculated by utilizing inflation rates, increase in funeral costs, and the projected date when services will be rendered. The future cost amount may be sent to the customer data storage unit 305 for storage by the data processing unit 300.

Additionally, the data processing unit 300 creates preneed insurance applications. The user or customer selects the insurance provider's plan(s) that best fits the needs of the customer. The insurance data storage unit 315 provides appropriate insurance application forms to the data processing unit 300. The insurance application forms relate to the customer data, the insurance quote data, and the selected insurance providers' plan(s). For example, if the customer decides to purchase insurance from insurance provider “A”, then the insurance data storage unit 315 provides the data processing unit 300 with the insurance application form of insurance provider “A”. Other necessary forms, such as those required by the insurance company or state law, are also provided by the insurance data storage unit 315 to the data processing unit 300. The user provides to the data processing unit 300 additional customer data required to complete the application forms. The data processing unit 300 prepares the insurance application, accordingly. The completed insurance application is provided to the customer data storage unit 305 for storing. The insurance application can then be sent to the insurance provider(s).

The insurance data storage unit 315 also provides the data processing unit 300 with the forms necessary to complete an insurance claim. The user can create preneed insurance claims relating to a purchased insurance policy. The data processing unit 300 receives customer data concerning the details of the claim. The insurance data storage unit 315 provides to the data processing unit 300 the appropriate insurance claim forms, and additional forms required by the insurance company or state law. The data processing unit 300 prepares the insurance claim forms and provides the insurance claim forms to the customer data storage unit 305 for storage. The insurance claim can then be sent to the insurance provider(s).

The data processing unit 300, the customer data storage unit 305, the quote data storage unit 310, and the insurance data storage unit 315 can be directly or indirectly in communication with each other through devices including, but not limited to, copper wire, coaxial cable, fiber optic cable, infrared devices, and RF signals.

The data processing unit 300 receives customer data, quote data, and insurance data. The customer data, quote data, and insurance data is received by the data processing unit 300 through a non-network computer system, although one skilled in the art will recognize that the customer data, quote data, and insurance data can also be received over a network of computers, such as the Internet or an intranet.

The customer data storage unit 305 receives and stores customer data from the data processing unit 300. Additionally, the customer data storage unit 305 provides stored customer data to the data processing unit 300. The customer data storage unit 305 can be a conventional volatile or non-volatile memory device capable of storing data. Memory devices capable of storing data generally include random access memory (RAM), flash memory, magnetic memory devices, optical memory devices, hard disk drives, floppy disks, CDs, minidisks, memory cards, or any other memory device capable of storing data.

The customer data storage unit 305 can alternatively be a removable memory device. Removable memory devices include, but are not limited to, removable volatile or non-volatile memory devices, optical storage mediums, magnetic storage mediums, hard disks, RAM memory cards, or any other removable memory data storage device.

The customer data storage unit 305 can also be a memory system comprising a multi-stage system of primary and secondary memory devices. The primary and secondary memory devices can be volatile or non-volatile memory, or combinations thereof. Either the primary or secondary memory device can be designed to operate as a cache for the other memory device. The secondary memory device can also serve as a backup to the primary memory device.

The customer data storage unit 305 can have a memory device configured as a simple database separated by a common delineator. The customer data storage unit 305 can alternatively be structured as a relational database using the structured-query-language (SQL). Such relational databases include mSQL, mySQL, or SQLplus. One skilled in the art will recognize that a relational database is usually managed by a database management system such as Oracle, Sybase, Microsoft SQL Server, Access, Ingress, or McKoi.

In another embodiment of the present invention, the customer data storage unit 305 is a remote data storage facility that is accessible through a networked based grid computing system or through a wireless network.

The customer data received, stored, and provided by the customer data storage unit 305 includes, but is not limited to, customer insurance quote information, customer insurance policy application information, customer insurance policy assignment information, and customer insurance claim information.

The customer insurance quote information includes: first name, middle initial, last name, sex, date of birth, current age, age nearest birth date, phone number, funeral selection type, state for the quote, funeral home location, current funeral costs, plan type (i.e., single or multi-pay, increased or standard), insurance company name, insurance plan, premium amount, face amount, commission, plan selection, insurance policy duration, and time payment rates (i.e., annual, semi-annual, quarterly, or monthly billed or monthly bank draft).

The customer insurance policy application information includes: name, date of birth, current age, sex, social security number, telephone number, age nearest birth date, street address, city, state, zip code, policy owner information, beneficiary information, policy information, health history information, remarks information, licensed agent information, bank information, information practices, and replacement information.

The policy owner information includes: payor, name, street address, city, state, zip code, sex, date of birth, social security number, telephone number, the relationship to the insured, and secondary address.

The beneficiary information includes: name, street address, city, state, zip code, telephone number, and the relationship to the insured.

The policy information includes: single pay plan, single pay premium amount paid, single plan amount of insurance, single pay policy number, single pay issue date, single pay application status, time pay plan, time pay premium amount paid, time pay amount of insurance, time pay frequency of payments, time pay method of payment, time pay policy number, time pay issue date, and time pay application status.

The health history information includes an inquiry as to whether the applicant is a patient in a hospital, or other facility, and an inquiry as to whether the applicant was told by a physician that he or she possessed a physical illness or condition.

The remarks information includes remarks, comments, and requests.

The licensed agent information includes: date, dated at city, dated at state, agency name, agency number, agent name, and agent number.

The bank information includes: account type, account number, bank name, street address, city, state, zip code, draw date, certificate number(s), telephone number, routing number, and inquiry to add listed certificate number(s) to an existing bank draft account.

The information practices includes: authorization to obtain an investigative report on applicant, election to be interviewed, and authorization to disclose personal information for marketing purposes.

The replacement information includes: inquiry as to whether the policy is intended to replace health insurance or annuities.

The customer insurance policy assignment information includes: insured name, single pay police/certificate number, time pay policy/certificate number, form type, type of assignment, cancel single pay assignment, cancel time pay assignment, funeral home name, funeral home address, signed date, city, and state.

The customer insurance claim information includes: name, social security number, date of birth, date of death, street address, city, state, zip code, claim funeral provider information, claim information, claim beneficiary information, claim medical information, and claim additional information.

The claim funeral provider information includes: funeral home name, telephone number, tax identification number, social security number, street address, city, state, zip code, funeral costs billed, and funeral home/provider representative.

The claim information includes: single pay policy number, single pay claim amount paid, single pay date paid, single pay claim status, and single pay filed date, time pay policy number, time pay claim amount paid, time pay date paid, time pay claim status, and time pay filed date, and inquiry for IRS backup withholdings.

The claim beneficiary information includes: name of the beneficiary, social security number, date of birth, street address, city, state, zip code, day telephone number, evening telephone number, and relationship to the insured.

The claim medical information includes: doctor name, doctor address, phone number, disease or condition, start date, and end date.

The claim additional information includes: cause of death, place of birth, and place of death.

The quote data storage unit 310 provides stored quote data to the data processing unit 300. In an embodiment of the present invention, the quote data storage unit 310 is any type of data storage device as described above for the customer data storage unit 305. The quote data storage unit 310 is configured as described above for the customer data storage unit 305. In an alternative embodiment, the quote data storage unit 310 is a remote data storage facility that is accessible through a networked based grid computing system or through a wireless network.

The quote data provided by the quote data storage unit 310 includes: single pay insurance company name, single pay sex, single pay plan name, single pay minimum coverage, single pay maximum coverage, single pay issue ages, single pay calculated ages, single pay insurance rates, single pay available states, single pay death benefits, single pay commissions, time pay insurance company name, time pay sex, time pay plan name, time pay minimum coverage, time pay maximum coverage, time pay issue ages, time pay calculated ages, time pay insurance rates, time pay available states, time pay payment duration, time pay death benefits, and time pay commissions.

The insurance data storage unit 315 provides stored insurance data to the data processing unit 300. The insurance data storage unit 315 is any type of data storage device as described above for the customer data storage unit 305. Additionally, the insurance data storage unit 315 is configured as described above for the customer data storage unit 305. The insurance data storage unit 315 is alternatively a remote data storage facility that is accessible through a networked based grid computing system or through a wireless network.

The insurance data provided by the insurance data storage unit 315 includes: insurance provider name(s), insurance provider(s) contact information, insurance provider(s) policy information, insurance provider(s) plan information, insurance provider(s) terms, conditions, and warranties, insurance provider(s) application forms, insurance provider(s) claim forms, insurance provider(s) assignment forms, and state specific forms.

One skilled in the art will recognize that the customer data storage unit 305, the quote data storage unit 310, and the insurance data storage unit 315 can be separate data storage devices or can be combined into one data storage device containing customer data, quote data, and insurance data. The data storage devices can be accessed locally on a client computer or can be accessed through a networked environment with logical connections to a remote computer. The remote computer can be a host computer, a server, a router, a peer device or other network node common to computer networks.

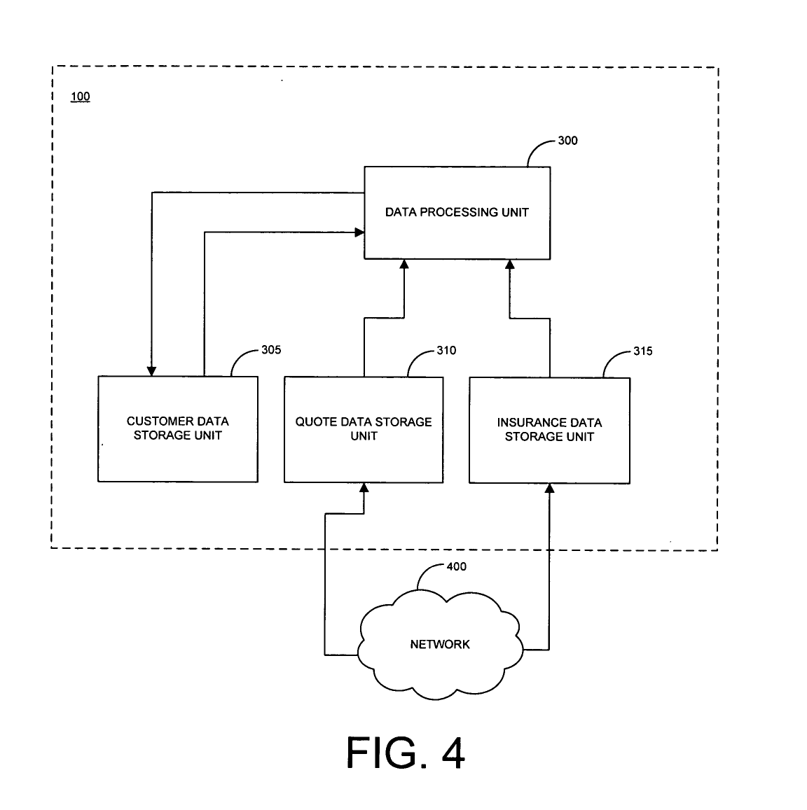

FIG. 4 is a block diagram illustrating a system for receiving quote data and insurance data through a computer network 400 in accordance with an embodiment of the present invention. The quote data storage unit 310 and the insurance data storage unit 315 are in communication with a computer network 400. The computer network 400 provides quote data to the quote data storage unit 310 and provides insurance data to the insurance data storage unit 315.

In a preferred embodiment of the present invention, the quote data storage unit 310 and the insurance data storage unit 315 is connected directly or indirectly to the computer network 400 through a network interface. The insurance quote is created in the same fashion as described above, however, the data is transferred over a computer network, instead of through a single computer.

The network interface can be an internal or external modem or other means of communicating with a computer network, as described above with reference to FIG. 2. One skilled in the art will recognize that the computer network 400 typically contains the infrastructure and facilities appropriate to connect a group of two or more communication devices (including, without limitation, a plurality of computer systems in communication with each other). The computer network 400 and communication devices (e.g., computer systems) may be configured in multiple network topologies including, but not limited to, star, bus, or ring configurations. Also, the computer network 400 and communication devices may be broadly categorized as belonging to a particular architecture including, but not limited to, peer-to-peer or client/server architectures. The computer network 400 may additionally be classified by the geographical location of the communication devices and the types thereof. For example, if the computer network 400 connects a plurality of computer systems or servers located proximate to each other, such as within a building, the computer network 400 is referred to as a local-area network (LAN); if the computer systems are located farther apart, the computer network 400 is generally referred to as a wide-area network (WAN), such as the Internet; if the computer systems are located within a limited geographical area, such as a university campus or military establishment, the computer network 400 is referred to as a campus-area network (CAN); if the computer systems are connected together within a city or town, the computer network 400 is referred to as a metropolitan-area network (MAN); and if the computer systems are connected together within a user's home, the computer network 400 is referred to as a home-area network (HAN). Alternatively, the computer network 400 is a remote computer that provides quote data and insurance data to the local computer system housing the quote data storage unit 310 and insurance data storage unit 315.

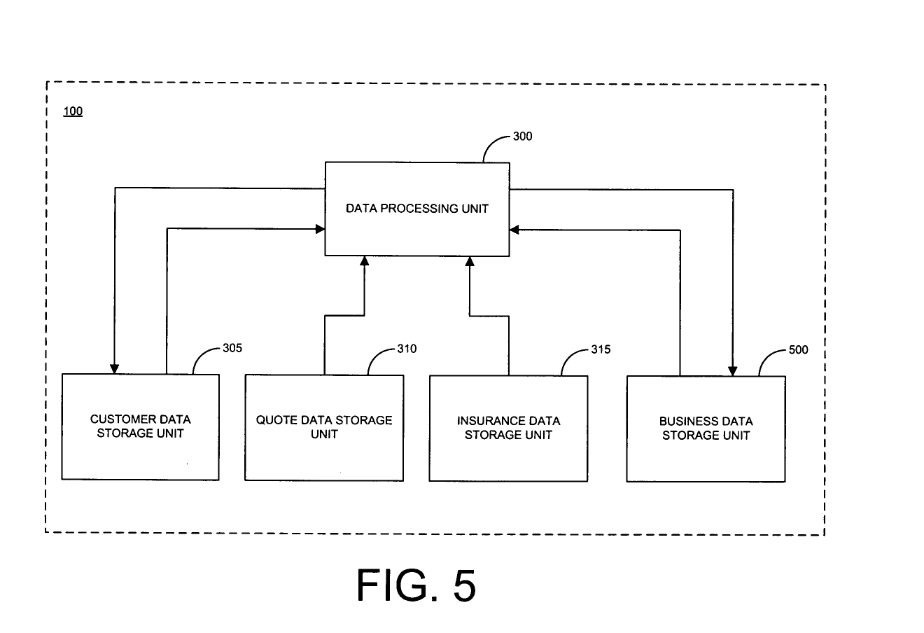

FIG. 5 is a block diagram illustrating a system for receiving business information for preneed services in accordance with an embodiment of the present invention. With reference to FIG. 5, a preferred system for implementing the present invention includes a business data storage unit 500. The business data storage unit 500 is in communication with the data processing unit 300.

The user can provide business data, such as a logo, to the data processing unit 300. The data processing unit 300 creates business forms using the business data provided. The business forms are provided to the business data storage unit 500 for storage. The business forms created by the data processing unit 300 and which contain the business logo can be used by the funeral home in its day to day business.

The business data storage unit 500 is in communication with the data processing unit 300 with a communication device described above with regard to the communication between the data processing unit 300, the customer data storage unit 305, the quote data storage unit 310, and the insurance data storage unit 315.

The business data storage unit 500 receives, stores, and provides business data to the data processing unit 300. The business data storage unit 500 is any type of data storage device as described above for the customer data storage unit 305. Also, the business data storage unit 500 is configured as described above for the customer data storage unit 305. The business data storage unit 500 is alternatively a remote data storage facility that is accessible through a networked based grid computing system or through a wireless network.

The business data received, stored, and provided by the business data storage unit 500 includes: funeral home/agency information, agent information, funeral selections information, agent accessibility information, quote page filters, funeral home/agency letterhead, funeral home business forms, funeral home/agency logos, funeral home/agency slogans, and funeral home/agency miscellaneous information.

The funeral home/agency information includes: funeral home/agency name, street address, city, state, zip code, telephone number, tax ID/SS number, active or inactive status, insurance company assignment, and agency number.

The agent information includes: agent name, insurance company assignment, agent insurance company number, agent state funeral director's number, and funeral home location assignment.

The funeral selections information includes the type of funeral, i.e., traditional service, direct cremation, memorial service, etc.

The agent accessibility information includes: agent first name, agent last name, agent username, agent password, agent role, agent status, records and software functions accessibility status.

The quote page filters include: option to display inflation information, messages and ratings, ability to select inflation factor, and include typed message.

One skilled in the art will recognize that the business data storage unit 500, the customer data processing unit 305, the quote data storage unit 310, and the insurance data storage unit 315 can be separate data storage devices or can be combined into one data storage device containing business data, customer data, quote data, and insurance data. Additionally, the business data storage unit 500 can be accessed in the same manner described above with regard to data storage devices and networked environments.

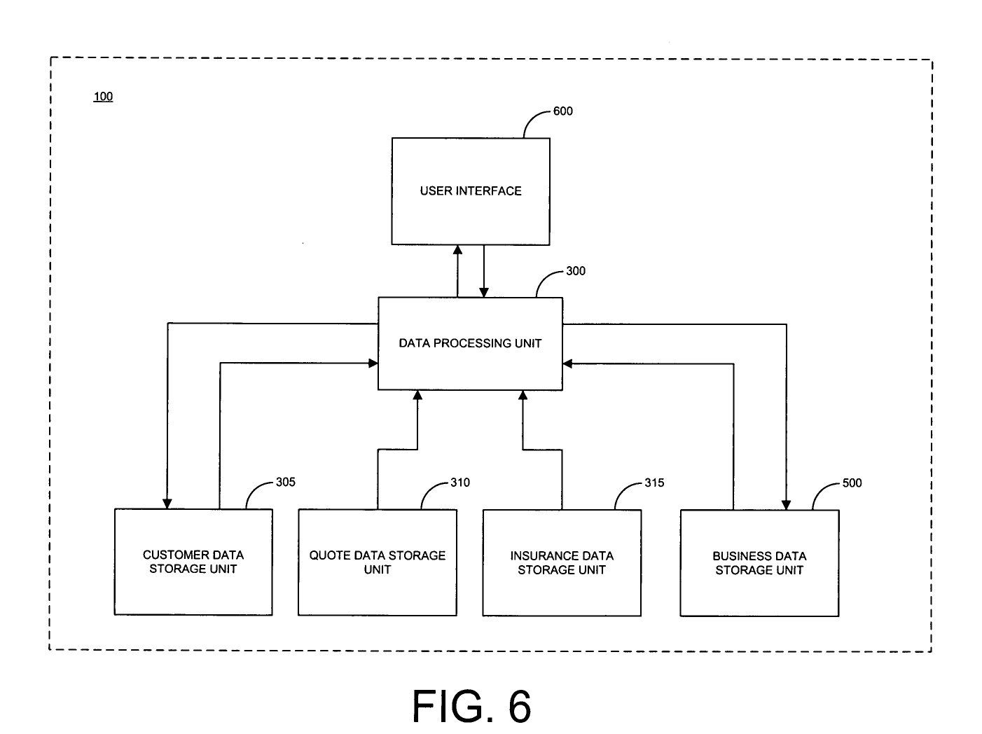

FIG. 6 is a block diagram illustrating a system with a user interface 600 for providing preneed insurance quotes in accordance with an embodiment of the present invention. In a preferred embodiment of the present invention, a user interface 600 provides the data processing unit 300 with customer data, business data, and instructional data. The customer data and business data received by the data processing unit 300 is user input or software generated input. The user interface 600 is in communication with the data processing unit 300.

The user interface 600 allows the user to provide customer or business data to the data processing unit 300. The user interface 600 generally is represented by a graphical user interface displayed by a computer monitor to the user. It provides the gateway for communication between the user and the data processing unit 300. For example, the user can request through the user interface 600 that a quote for insurance be made. The request is sent to the data processing unit 300 for processing. The user interface 600 can also be used to provide the customer information necessary to create an insurance quote. The data processing unit 300 creates the report and provides the report to the user interface 600 for display.

The communication between the user interface 600 and the data processing unit 300 is with any communication device such as the communication devices described above with regard to the data processing unit 300 and the data storage units. The data processing unit 300 provides insurance data, quote data, and status data to the user interface 600 for display.

Instructional data includes: data requests, save requests, report creation requests, form requests, application requests, search requests, quote requests, claim requests, assignment requests, deleting data requests, printing requests, security requests, editing requests, data backup requests, data restore requests, data repair requests, view log file requests, change website uniform resource locator (URL) requests, help requests, data synchronization requests, uploading requests, updating requests, and process termination requests.

Status data includes: data retrieval status, saving status, report creation status, form retrieval status, application retrieval status, search results, quote retrieval status, claim retrieval status, assignment retrieval status, data deletion status, printing status, security status, editing status, data backup status, data restore status, data repair status, change website URL status, data synchronization status, upload status, update status, and process termination status.

The user interface 600 receives customer data and business data. For example, a user can input the customer data and business data through a graphical user interface displayed on a computer screen. The user can input the customer data and business data through a computer network, directly or indirectly, to the user interface 600. Likewise, the user interface 600 can transmit and provide customer data and business data to the data processing unit 300 through a computer network, or can transmit and provide customer data and business data remotely.

Similarly, the user interface 600 provides the data processing unit 300 with instructional data in response to user interaction. For example, the user can, through the user interface 600, direct the data processing unit 300 to store customer data and business data. The data processing unit 300 responds by providing the customer data and business data to the customer data storage unit 305 and the business data storage unit 500, respectively. The data processing unit 300 then provides status data to the user interface 600 to display to the user that the system has successfully stored the customer data and the business data.

In another example, the user interface 600 sends instructional data to the data processing unit 300 requesting to receive stored customer data, stored quote data, stored insurance data, and stored business data. The data processing unit 300 receives stored customer data, stored quote data, stored insurance data, and stored business data from the customer data storage unit 305, quote data storage unit 310, insurance data storage unit 315, and business data storage unit 500, respectively. Then, the data processing unit 300 provides the stored data to the user interface 600 for display. Additionally, the data processing unit 300 provides the user interface 600 with status data indicating that the request was performed successfully.

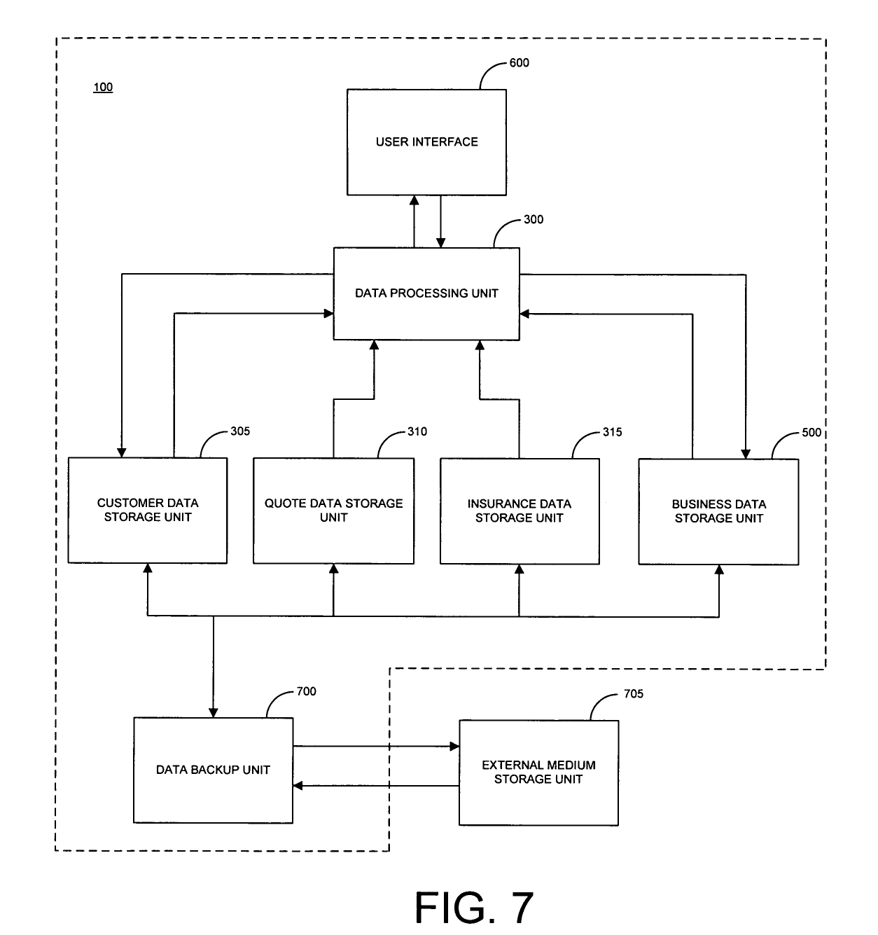

FIG. 7 is a block diagram illustrating a data backup system for preneed services in accordance with an embodiment of the present invention. With reference to FIG. 7, a preferred system for implementing the present invention includes a data backup unit 700 and external medium storage unit 705. The data backup unit 700 is in communication with the customer data storage unit 305, the quote data storage unit 310, the insurance data storage unit 315, and the business data storage unit 500.

The data backup unit 700 receives all of the data stored in the customer data storage unit 305, the quote data storage unit 310, the insurance data storage unit 315, and the business data storage unit 500. The data is sent to the external medium storage unit 705 for storage. The purpose of the data backup is to provide the user with the ability to restore data that has become corrupt.

The communication between the data backup unit 700 and the storage units is with any communication device such as the communication devices described above with regard to the data processing unit 300 and the data storage units. The data backup unit 700 receives stored customer data, stored quote data, stored insurance data, and stored business data from the customer data storage unit 305, the quote data storage unit 310, the insurance data storage unit 315, and the business data storage unit 500, respectively.

In an alternative embodiment of the present invention, the data backup unit 700 compresses the received data before providing the data for storage. The data compression can be implemented with any hardware or software capable of compressing data using any compression scheme. The data backup unit 700 provides the compressed or uncompressed customer data, quote data, insurance data, and business data to the external medium storage unit 705 for storing.

The data backup unit 700 receives customer data, quote data insurance data, and business data from the external medium storage unit 705. If necessary, the data backup unit 700 decompresses the received data before providing the data to the storage units. Data decompression can be implemented with any hardware or software capable of decompressing data using any decompression scheme. The data backup unit 700 provides the decompressed customer data, quote data, insurance data, and business data to the customer data storage unit 305, the quote data storage unit 310, the insurance data storage unit 315, and the business data storage unit 500.

The external medium storage unit 705 is in communication with the data backup unit 700. The communication between the external medium storage unit 705 and the data backup unit 700 is with any communication device such as the communication devices described above. The external medium storage unit 705 provides customer data, quote data, insurance data, and business data to the data backup unit 700. Additionally, the external medium storage unit 705 is any type of data storage device as described above for the customer data storage unit 305. The external medium storage unit 705 is configured as described above for the customer data storage unit 305.

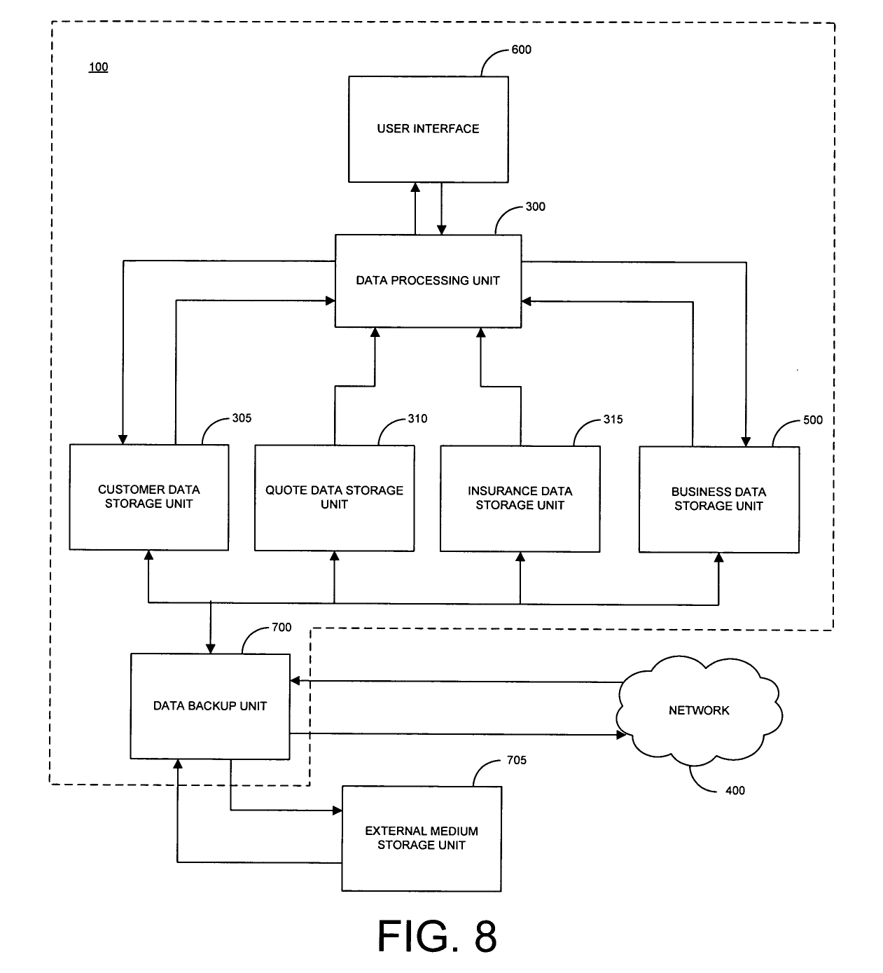

FIG. 8 is a block diagram illustrating a data backup system for preneed services through a computer network in accordance with an embodiment of the present invention. In a preferred embodiment of the present invention, the data backup unit 700 is in communication with a computer network 400. The data backup unit 700 provides compressed or uncompressed customer data, quote data, insurance data, and business data to the computer network 400 for storing on an external medium, such as a network server or host computer.

Additionally, the computer network 400 provides customer data, quote data, insurance data, and business data to the data backup unit 700. The data backup unit 700 is connected directly or indirectly to the computer network 400 through a network interface. The network interface is any type of interface connected to a network as described above. The computer network 400 is any type of network connecting computers as discussed above. In an alternative embodiment, the computer network 400 is a remote storage facility that provides customer data, quote data, insurance data, and business data to the data backup unit 700.

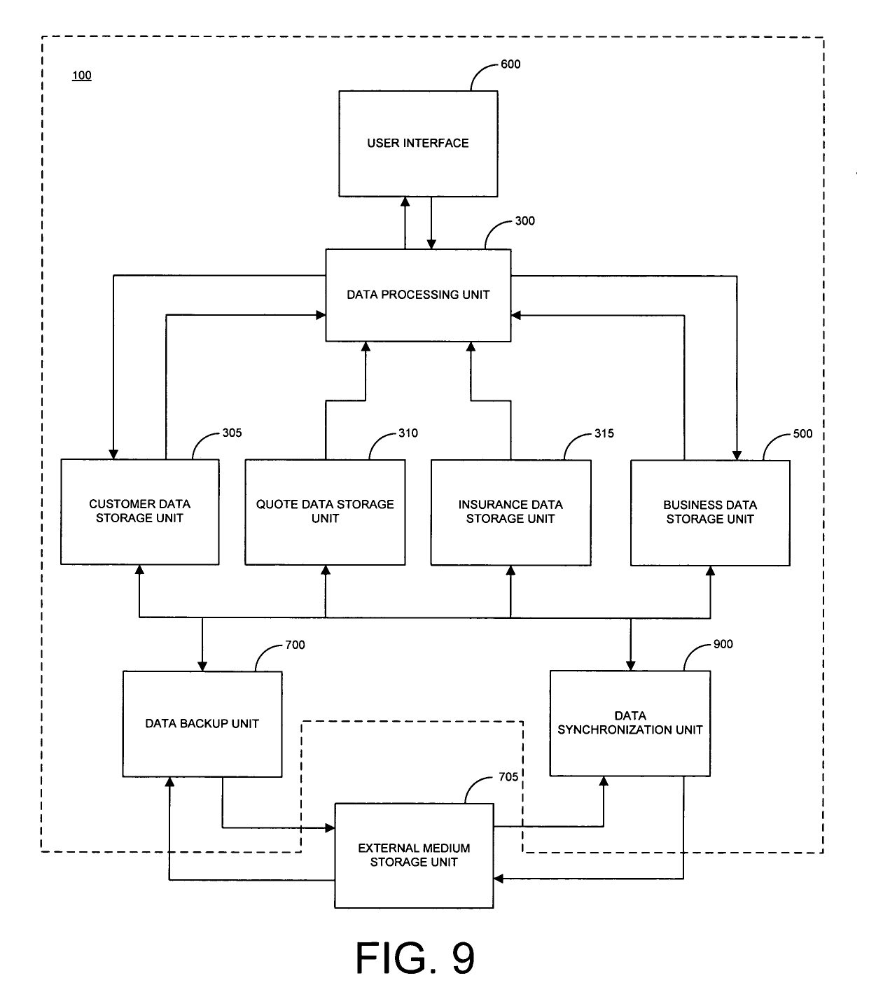

FIG. 9 is a block diagram illustrating a data synchronization system for preneed services in accordance with an embodiment of the present invention. With reference to FIG. 9, the present invention preferably includes a data synchronization unit 900. The data synchronization unit 900 is in communication with the customer data storage unit 305, the quote data storage unit 310, the insurance data storage unit 315, and the business data storage unit 300.

The data synchronization unit 900 receives all of the data stored in the customer data storage unit 305, the quote data storage unit 310, the insurance data storage unit 315, and the business data storage unit 500. The data is transferred to the external medium storage unit 705 for storing. In addition, any data on the external medium storage unit 705 that is not found on the storage units is transferred to the respective storage unit for storage. The effect is a database that has been synchronized with the data stored on the external data storage unit 705. When data is stored on separate computers, synchronization ensures that the data stored in the databases of each computer is identical.

The communication between the data synchronization unit 900 and the storage units is with any communication device such as the communication devices described above with regard to the data processing unit 300 and the data storage units. The data synchronization unit 900 receives stored customer data, stored quote data, stored insurance data, and stored business data from the customer data storage unit 305, the quote data storage unit 310, the insurance data storage unit 315, and the business data storage unit 500, respectively. The data synchronization unit 900 provides stored customer data, stored quote data, stored insurance data, and stored business data to the external medium storage unit 705 for storage during synchronization.

In an another embodiment, the data synchronization unit 900 compresses and decompresses the customer data, quote data, insurance data, and business data as described above with regard to the data backup unit 700. The external medium storage unit 705 provides synchronized customer data, synchronized quote data, synchronized insurance data, and synchronized business data to the data synchronization unit 900. Furthermore, the data synchronization unit 900 provides synchronized customer data, synchronized quote data, synchronized insurance data, and synchronized business data to the customer data storage unit 305, the quote data storage unit 310, the insurance data storage unit 315, and the business data storage unit 500, respectively. One skilled in the art will recognize that synchronized data involves a data set from a first source and a data set from a second source, in which data from the first source that is not common to the second source is added to the second source, while the data from the second source that is not common to the first source is added to the first source. As a result, the first data source contains identical data as the second data source.

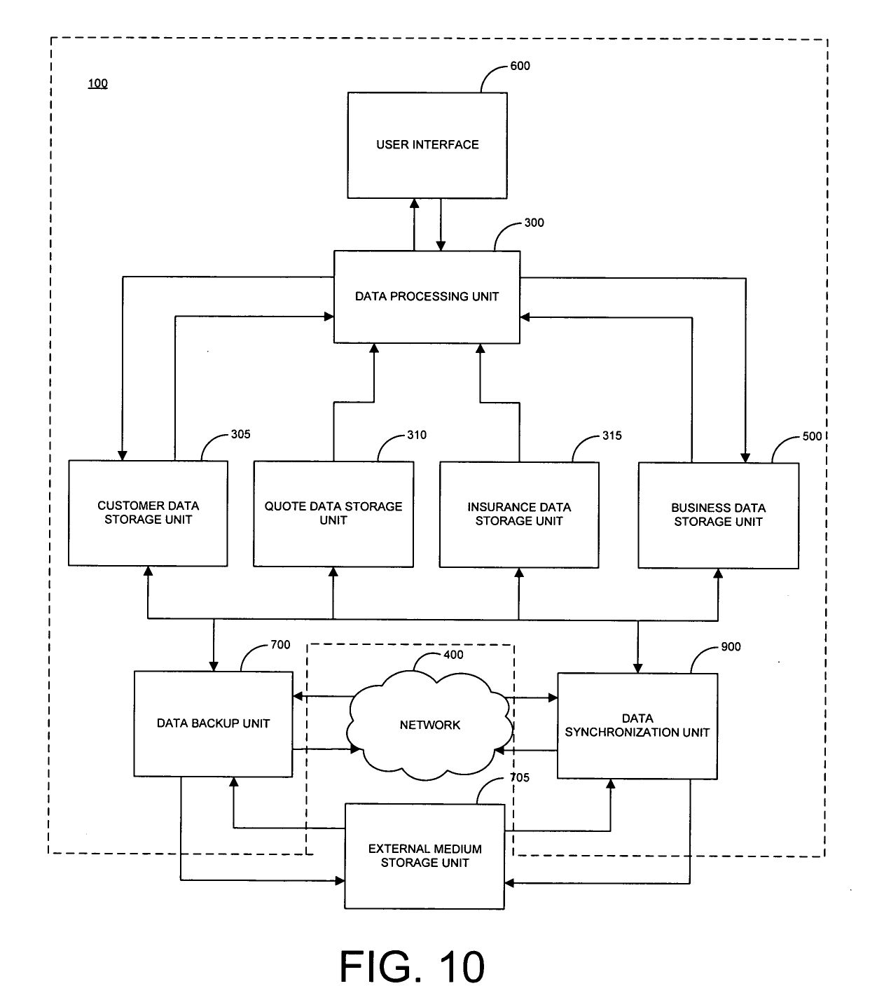

FIG. 10 is a block diagram illustrating a data synchronization system for preneed services through a computer network in accordance with an embodiment of the present invention. Preferably, the data synchronization unit 900 is in communication with a computer network 400. The data synchronization unit 900 provides compressed or uncompressed customer data, quote data, insurance data, and business data to the computer network 400 for storing on an external medium, such as a network server or host computer. Additionally, the computer network 400 provides synchronized customer data, synchronized quote data, synchronized insurance data, and synchronized business data to the data synchronization unit 900.

The data synchronization unit 900 is connected directly or indirectly to the computer network 400 through a network interface. The network interface is any type of interface connected to a network as described above. Furthermore, the computer network 400 is any type of network connecting computers as discussed above. Alternatively, the computer network 400 is a remote storage facility that provides synchronized customer data, synchronized quote data, synchronized insurance data, and synchronized business data to the data synchronization unit 900.

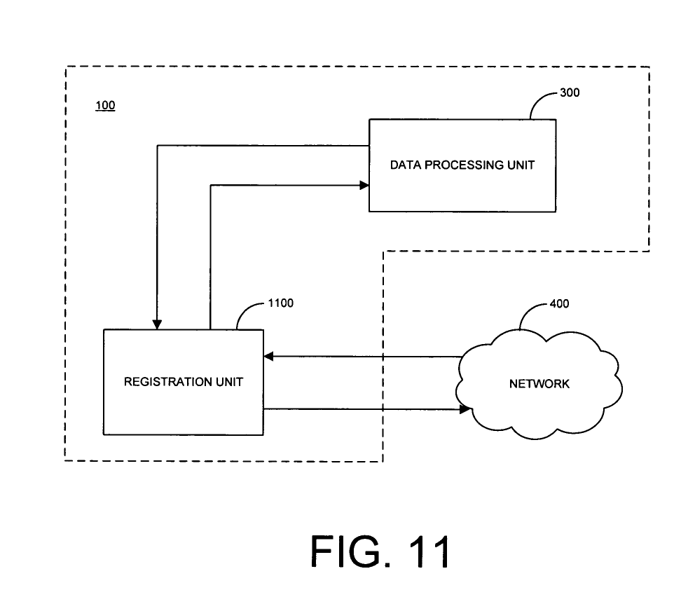

FIG. 11 is a block diagram illustrating a registration system for preneed services through a computer network in accordance with an embodiment of the present invention. Referencing FIG. 11, the present invention includes a registration unit 1100. The registration unit 1100 is in communication with the data processing unit 300. The registration unit 1100 receives registration information from the user, through the data processing unit 300. The information provided by the user allows the registration of the preneed insurance services system. Registration is common in the software industry. It provides valuable information to the software vendor and helps to ensure that the software is a legal copy. Registration is often required in order to receive updates or extended features of the software application.

The communication between the registration unit 1100 and the data processing unit 300 is with any communication device such as the communication devices described above with regard to the data processing unit 300 and the data storage units. The registration unit 1100 receives registration data from the data processing unit 300. Additionally, the registration unit 1100 is in communication with the computer network 400. The registration unit 1100 is connected directly or indirectly to the computer network 400 through a network interface. The network interface is any type of interface connected to a network as described above. Also, the computer network 400 is any type of network connecting computers as discussed above. The computer network 400 provides registration data to the registration unit 1100. The registration unit 1100 uses the registered data to activate features of the system of the present invention that have not already been activated.

Registration data includes: user first name, user last name, street address, city, state, zip code, telephone number, credit card name, credit card number, credit card expiration, pin number, company name, software serial number, activation number, accessibility code for system features, registration status, secure encryption key, certificates, and authentication information.

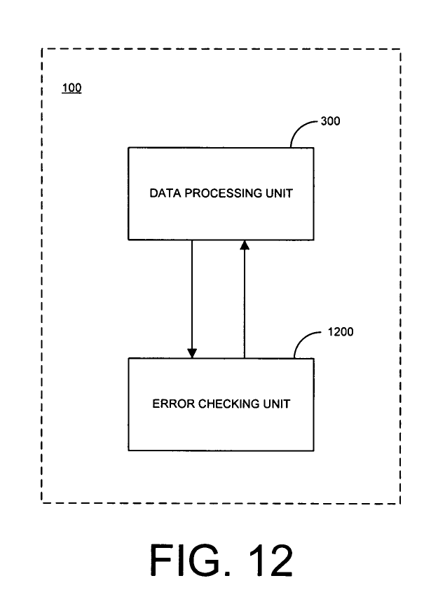

FIG. 12 is a block diagram illustrating an error checking system for preneed services in accordance with an embodiment of the present invention. In a preferred embodiment of the present invention, the system includes an error checking unit 1200 which is in communication with the data processing unit 300. The error checking unit 1200 ensures data integrity in the preneed insurance services system. For example, the error checking unit 1200 can prevent a user from making a claim on an insurance policy, unless the customer has been issued an insurance policy. Additionally, duplicate information can be cross-checked to decrease the chance of mistakes in insurance quotes, applications, claims, or business forms.

The communication between the error checking unit 1200 and the data processing unit 300 is with any communication device such as the communication devices described above. The data processing unit 300 provides the error checking unit 1200 with proposed data. The error checking unit 1200 provides the data processing unit 300 with the status of the data validity.

Proposed data includes: customer data, business data, quote data, and insurance data.

The status of the data validity includes: success status, failure status, inconsistent data error, missing data error, invalid data error, nonsensical data error, and processing errors.

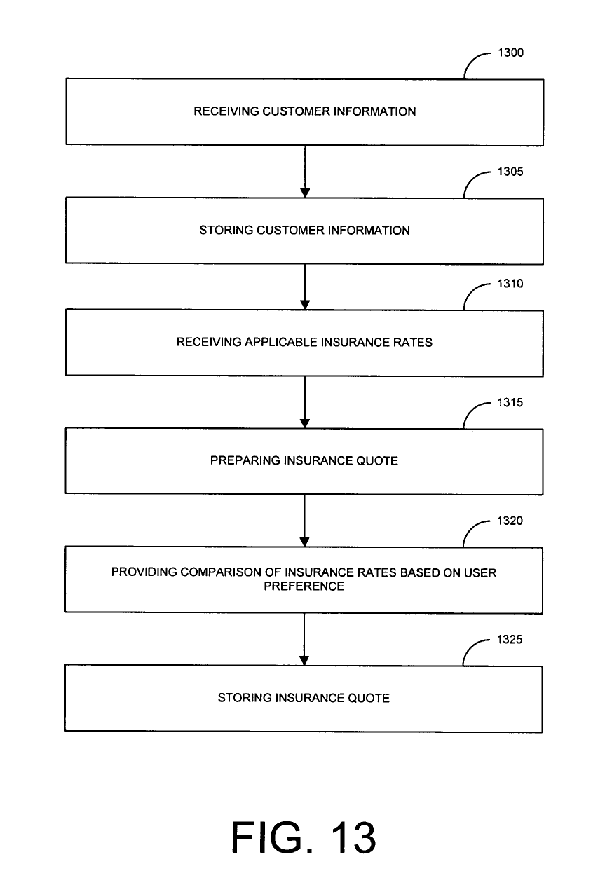

FIG. 13 is a flow chart illustrating a method of providing preneed insurance quotes in accordance with an embodiment of the present invention. Initially, the data processing unit 300 receives customer information 1300 from the user interface 600. The data processing unit 300 provides the customer information to the customer data storage unit 305 for storing 1305. The data processing unit 300 then receives applicable quote data 1310 from the quote data storage unit 310. The quote data corresponds to the received customer data—for example, the quote data might contain only the preneed insurance quotes available in the customer's domicile state. The insurance quote is prepared 1315 by the data processing unit 300. The preparation of the insurance quote entails error checking by the error checking unit 1200 for data consistency and availability. Additionally, the preparation of the insurance quote can require calculating rates for different terms specified in the customer data. The data processing unit 300 provides a comparison of the insurance rates 1320 to the user interface 600 based on the user's preference. The user can request that the insurance rates be ordered by the lowest premium, highest face amount, or highest commission amount. The user interface 600 displays the prepared insurance quote to the user via a graphical user interface displayed on a display device. Finally, the data processing unit 300 stores the insurance quote 1325 as customer data in the customer data storage unit 305.

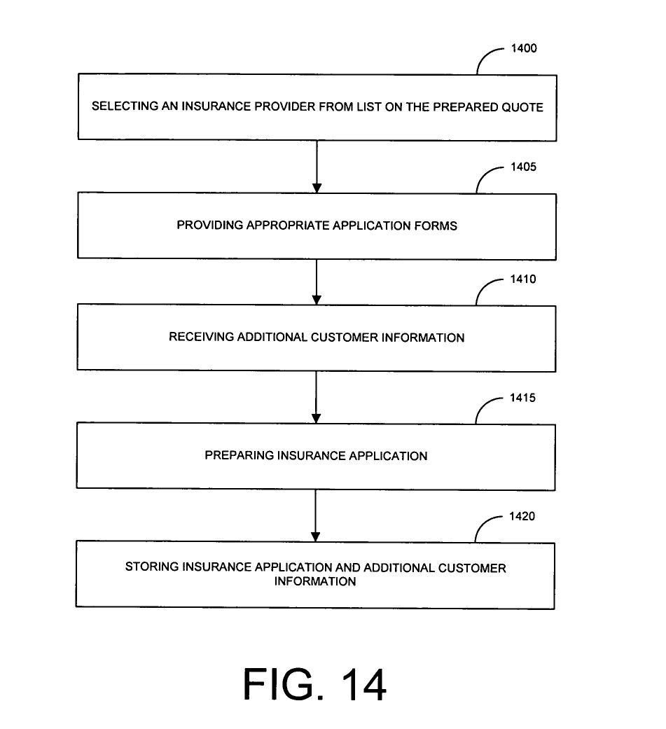

FIG. 14 is a flow chart illustrating a method of preparing preneed insurance applications in accordance with an embodiment of the present invention. The user can select an insurance provider(s) from the list on the prepared quote 1400 through the graphical user interface provided by the user interface 600. The data processing unit 300 receives the appropriate insurance application forms 1405 from the insurance data storage unit 315. The insurance data storage unit 315 provides insurance data pertaining to the customer information and the selected insurance provider(s). For example, a user selecting insurance provider “A” will be provided with insurance forms relating to the customer's domicile state and insurance provider “A”. Additionally, the insurance data storage unit 315 will provide any other forms that might be required by state regulation. The appropriate application forms are provided by the data processing unit 300 to the user interface 600 for displaying to the user. Then, the data processing unit 300 receives additional customer information 1410 from the user to complete the appropriate application forms. The data processing unit 300 prepares the insurance application 1415 with the additional customer information. The error checking unit 1200 is used to ensure that the data received is valid and complete. For example, an insurance quote may be necessary for an application to be completed. Finally, the data processing unit 300 provides the prepared insurance application and additional customer information 1420 as customer data to the customer data storage unit 305 for storing. Additionally, the prepared preneed application may be printed and mailed directly to the appropriate insurance company or may be transmitted electronically to the appropriate insurance company for processing.

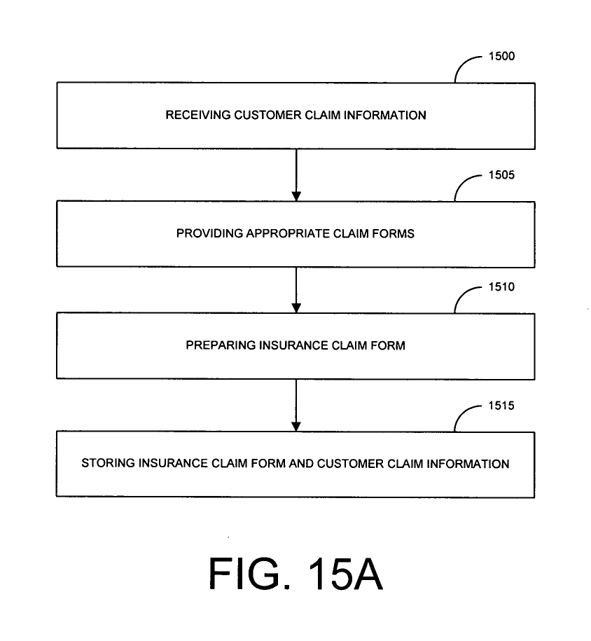

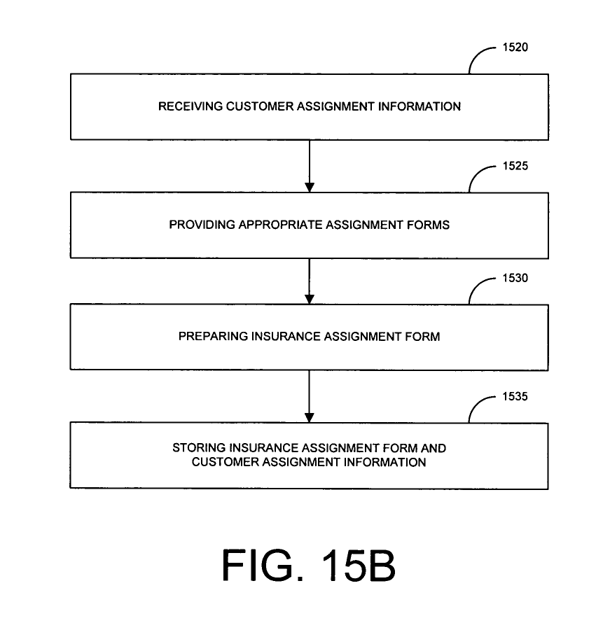

FIG. 15A is a flow chart illustrating a method of preparing preneed insurance claim forms in accordance with an embodiment of the present invention. The user can initiate a request for an insurance claim through the graphical user interface provided by the user interface 600. The data processing unit 300 receives customer claim information 1500 inputted from the user interface 600 and provided by the customer data storage unit 305. The insurance data storage unit 315 provides insurance data, such as claim forms 1505, pertaining to the customer information and the insurance provider. For example, a customer making a claim will be provided claim forms relating to the customer information provided and the insurance provider that issued the policy. Additionally, the insurance data storage unit 315 will provide any other forms that might be required by state regulation. The data processing unit 300 prepares the insurance claim form 1510. The preparation of the insurance claim form 1510 requires error checking provided by the error checking unit 1200. For example, it may be necessary for an insurance policy to have been issued, or for an insurance application to exist, before a customer can make a claim. The data processing unit 300 provides the insurance claim form and the customer claim information 1515 as customer data to the customer data storage unit 305 for storing.

FIG. 15B is a flow chart illustrating a method of preparing preneed insurance assignment forms in accordance with an embodiment of the present invention. The user can initiate a request for an insurance assignment through the graphical user interface provided by the user interface 600. The data processing unit 300 receives customer assignment information 1520 inputted from the user interface 600 and provided by the customer data storage unit 305. The insurance data storage unit 315 provides insurance data, such as assignment forms 1525, pertaining to the customer information and the insurance provider. For example, a customer making an assignment will be provided assignment forms relating to the customer information provided. Additionally, the insurance data storage unit 315 will provide any other forms that might be required by state regulation. The data processing unit 300 prepares the insurance assignment form 1530. The preparation of the insurance assignment form 1530 requires error checking provided by the error checking unit 1200. For example, it may be necessary for an insurance policy to have been issued, or for an insurance application to exist, before a customer can make an assignment. The data processing unit 300 provides the insurance assignment form and the customer assignment information 1535 as customer data to the customer data storage unit 305 for storing.

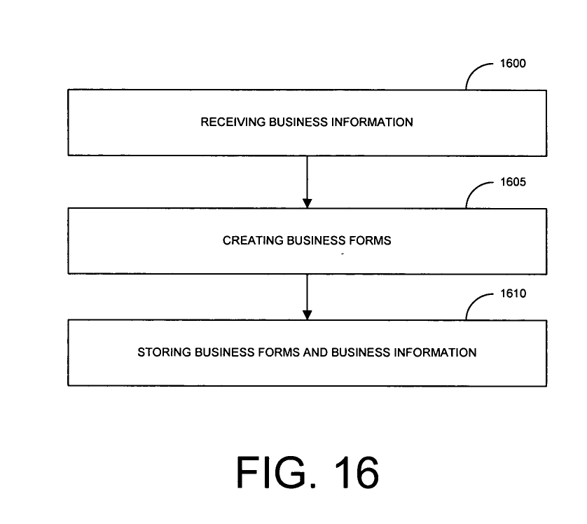

FIG. 16 is a flow chart illustrating a method of creating preneed business forms in accordance with an embodiment of the present invention. The data processing unit 300 receives business information 1600 through the graphical user interface provided by the user interface 600. For example, a user might provide a logo for the funeral home business for use on certain forms and applications. The data processing unit 300 creates the business forms 1605 using the received business information. Creating the business forms involves error checking by the error checking unit 1200 for data validity. For example, business data, such as a logo, may be required to be in a certain format before it will be acceptable by the data processing unit 300. The data processing unit 300 provides the business information and business forms 1610 as business data to the business data storage unit 500 for storing. Such preneed business forms may include correspondence letters, customized preneed insurance applications or claim forms, and other appropriate documentation that may be used by a funeral home business. For example, the preneed insurance services system 100 may generate follow-up letters to customers to inquire whether the customer would like to purchase the quoted preneed insurance. Additionally, the business data storage unit 500 may store calendar information or a reminder that triggers the preneed insurance services system 100 to remind an agent to follow-up with a customer after a predetermined period of time.

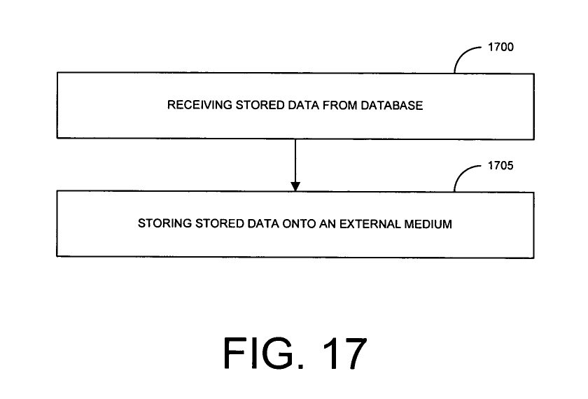

FIG. 17 is a flow chart illustrating a method of backing up preneed services data in accordance with an embodiment of the present invention. The data backup unit 700 receives stored data from the database 1700. More specifically, the data backup unit 700 receives stored customer data, stored quote data, stored insurance data, and stored business data from the customer data storage unit 305, the quote data storage unit 310, the insurance data storage unit 315, and the business data storage unit 500, respectively. The data backup unit 700 provides the stored data 1705 to the external medium storage unit 705 for storing. If data becomes corrupt in the customer data storage unit 305, the quote data storage unit 310, the insurance data storage unit 315, or the business data storage unit 500 the data can be recovered or restored by accessing the external medium storage unit 705 containing the backup of the data.

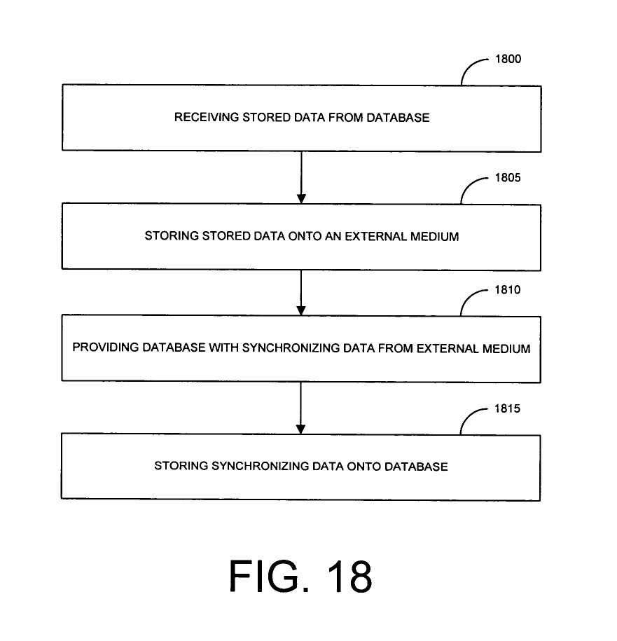

FIG. 18 is a flow chart illustrating a method of synchronizing preneed services data in accordance with an embodiment of the present invention. The data synchronization unit 900 receives stored data from the database 1800. More specifically, the data synchronization unit 800 receives stored customer data, stored quote data, stored insurance data, and stored business data from the customer data storage unit 305, the quote data storage unit 310, the insurance data storage unit 315, and the business data storage unit 500, respectively. The data synchronization unit 900 provides the stored data 1805 to the external medium storage unit 705 for storing. Next, the external medium storage unit 705 provides synchronized customer data, synchronized quote data, synchronized insurance data, and synchronized business data 1810 to the data synchronization unit 900. The data synchronization unit 900, in turn, provides synchronized customer data, synchronized quote data, synchronized insurance data, and synchronized business data 1815 to the customer data storage unit 305, the quote data storage unit 310, the insurance data storage unit 315, and the business data storage unit 500, respectively, for storing.

The methods discussed above can be implemented through computer-executable instructions contained in a computer-readable medium.

While this invention has been described in detail with particular reference to embodiments thereof, it will be understood that variations and modifications can be effected within the scope of the invention as defined in the appended claims.

1. A preneed insurance system comprising:
a data processing unit adapted to receive customer data, quote data, and preneed insurance data;
a customer data storage unit in communication with said data processing unit, said customer data storage unit adapted to receive and store the customer data from said data processing unit, said customer data storage unit further adapted to provide stored customer data to said data processing unit;
a quote data storage unit in communication with said data processing unit, said quote data storage unit adapted to provide stored quote data to said data processing unit; and
an insurance data storage unit in communication with said data processing unit, said insurance data storage unit adapted to provide stored preneed insurance data to said data processing unit.

2. The system of claim 1, wherein said quote data comprises a plurality of rates from competitive preneed insurance companies.

3. The system of claim 1, wherein said quote data storage unit is further adapted to receive quote data via a computer network, wherein said quote data storage unit is still further adapted to store quote data.

4. The system of claim 3, wherein said insurance data storage unit is further adapted to receive preneed insurance data via a computer network, wherein said insurance data storage unit is still further adapted to store preneed insurance data.

5. The system of claim 4, the system further comprising a business data storage unit in communication with said data processing unit, said business data storage unit adapted to receive and store business data from said data processing unit, said business data storage unit further adapted to provide stored business data to said data processing unit.

6. The system of claim 3, the system further comprising a user interface in communication with said data processing unit, said user interface adapted to receive customer data and business data,
wherein said user interface is further adapted to provide customer data, business data, and instructional data to said data processing unit, and
wherein said data processing unit is further adapted to provide preneed insurance data, quote data, and status data to said user interface.

7. The system of claim 6, the system further comprising:
a data backup unit in communication with each of said customer data storage unit, said quote data storage unit, said insurance data storage unit, and said business data storage unit, wherein said data backup unit is adapted to receive stored customer data, stored quote data, stored preneed insurance data, and stored business data, wherein said data backup unit is adapted to provide customer data, quote data, preneed insurance data, and business data to said customer data storage unit, said quote data storage unit, said insurance data storage unit, and said business data storage unit; and
an external medium storage unit in communication with said data backup unit, wherein said data backup unit adapted to provide customer data, quote data, preneed insurance data, and business data to said external medium storage unit for backup, wherein said external medium storage unit adapted to provide customer data, quote data, preneed insurance data, and business data to said data backup unit.

8. The system of claim 7, wherein said data backup unit is further adapted to receive and provide stored customer data, stored quote data, stored preneed insurance data, and stored business data via a computer network.

9. The system of claim 7, the system further comprising:
a data synchronization unit in communication with said customer data storage unit, said quote data storage unit, said insurance data storage unit, and said business data storage unit, said data synchronization unit adapted to receive stored customer data, stored quote data, stored preneed insurance data, and stored business data; and
an external medium storage unit in communication with said data synchronization unit, said data synchronization unit adapted to provide customer data, quote data, insurance preneed data, and business data to said external medium storage unit;
wherein said data synchronization unit is further adapted to receive synchronized customer data, synchronized quote data, synchronized preneed insurance data, and synchronized business data from said external medium storage unit;
wherein said data synchronization unit still further adapted to provide synchronization customer data to said customer storage unit, synchronized quote data to said quote data storage unit, synchronized preneed insurance data to said insurance data storage unit, and synchronized business data to said business data storage unit.

10. The system of claim 9, wherein said data synchronization unit is further adapted to receive and provide synchronized customer data, synchronized quote data, synchronized preneed insurance data, and synchronized business data via a computer network.

11. The system of claim 9, the system further comprising a registration unit in communication with said data processing unit, said registration unit adapted to receive registration data from said data processing unit, wherein said registration unit is further adapted to provide and receive registration data through a computer network.

12. The system of claim 11, the system further comprising an error checking unit in communication with said data processing unit, said error checking unit adapted to receive proposed data from said data processing unit, said error checking unit further adapted to provide said data processing unit with status of data validity.

13. A method for providing preneed insurance services comprising:
receiving from a user interface customer information necessary for preparing insurance quotes;
storing the customer information data into a database;
receiving applicable preneed insurance rates based on the received customer information;
preparing preneed insurance quotes for all applicable insurance providers based on the received customer information;
providing a comparison of the prepared preneed insurance quotes according to user preference; and
storing prepared preneed insurance quotes into a database.

14. The method of claim 13, the method further comprising:
selecting an insurance provider from the list of prepared insurance quotes for the customer;
providing the appropriate application forms for the selected insurance provider based on received customer data;
receiving from the user interface additional customer information for the preneed insurance application;
preparing an preneed insurance application form using the appropriate application form for the selected insurance provider and based on the received customer information; and
storing the preneed insurance application and additional customer information into a database.

15. The method of claim 14, the method further comprising:
receiving from the user interface customer information regarding a claim on an issued preneed insurance policy;
providing the appropriate claim forms for insurance provider based on the received customer information;
preparing an preneed insurance claim form using the appropriate claim form for the insurance provider and based on the received customer information; and
storing the preneed insurance claim and customer information into a database.

16. The method of claim 15, the method further comprising:
receiving from the user interface business information for customizing business forms;
creating preneed business forms from the received business information; and
storing the created preneed business forms and received business information into a database.

17. The method of claim 16, the method further comprising:
receiving all stored data from database; and
storing stored data onto an external medium.

18. The method of claim 17, the method further comprising:
receiving all stored data from database;
storing stored data onto an external medium;
providing database with synchronizing data from external medium that is not on the database; and
storing synchronizing data onto database.

19. A computer-readable medium having computer-executable instructions for preneed insurance services, where said computer-executable instructions perform steps comprising:
receiving from a user interface customer information necessary for preparing insurance quotes;
storing the customer information data into a database;
receiving applicable preneed insurance rates based on the received customer information;
preparing preneed insurance quotes for all applicable insurance providers based on the received customer information;
providing a comparison of the prepared preneed insurance quotes according to user preference; and
storing prepared preneed insurance quotes into a database.

20. The computer-readable medium of claim 19, wherein the computer-executable instructions perform steps further comprising:
selecting an insurance provider from the list of prepared insurance quotes for the customer;
providing the appropriate application forms for the selected insurance provider based on received customer data;
receiving from the user interface additional customer information for the preneed insurance application;
preparing an preneed insurance application form using the appropriate application form for the selected insurance provider and based on the received customer information; and
storing the preneed insurance application and additional customer information into a database.

21. The computer-readable medium of claim 20, wherein the computer-executable instructions perform steps further comprising:
receiving from the user interface customer information regarding a claim on an issued preneed insurance policy;
providing the appropriate claim forms for insurance provider based on the received customer information;
preparing an preneed insurance claim form using the appropriate claim form for the insurance provider and based on the received customer information; and
storing the preneed insurance claim and customer information into a database.

22. The computer-readable medium of claim 21, wherein the computer-executable instructions perform steps further comprising:
receiving from the user interface business information for customizing business forms;
creating preneed business forms from the received business information; and
storing the created preneed business forms and received business information into a database.

23. The computer-readable medium of claim 22, wherein the computer-executable instructions perform steps further comprising:
receiving all stored data from database; and
storing stored data onto an external medium.

24. The computer-readable medium of claim 23, wherein the computer-executable instructions perform steps further comprising:
receiving all stored data from database;
storing stored data onto an external medium;
providing database with synchronizing data from external medium that is not on the database; and
storing synchronizing data onto database.
